(19) United States
(12) Patent Application Publication
(10) Pub. No.: US 2019/0331540 A1
(43) Pub. Date: Oct. 31, 2019

(54) Resistive pressure sensor and wearable device

(71) Applicant: ZhuHai AdvanPro Technology Co.,Ltd., Guangdong (CN)

(72) Inventors: Fei WANG, Guangdong (CN); Yangyong WANG, HONGKONG (CN); Liangkui RAO, Guangdong (CN); Shihua LUO, Guangdong (CN)

(21) Appl. No.: 15/563,565

(22) PCT Filed: May 27, 2017
(86) PCT No.: PCT/CN2017/086345

§ 371 Date: Sep. 30, 2017

(30) Foreign Application Priority Data
Jan. 23, 2017 (CN) 201710063241.4

(51) Int. Cl. G01L 1/22; C08G 77/04; C08K 3/04; D02G 3/12; D03D 1/00

(52) U.S. Cl. CPC G01L 1/22; C08G 77/04; C08K 3/04; D02G 3/12; D10B 2101/20; C08K 2201/001; D10B 2331/04; D10B 2331/10; D03D 1/0088

(57) ABSTRACT

The application provides a resistive pressure sensor and a wearable device. The resistive pressure sensor comprises a first conductive layer, an elastic insulating layer, and a second conductive layer. The elastic insulating layer is provided on the surface of the first conductive layer, and the elastic insulating layer comprises at least one through hole; the second conductive layer is provided on the surface of the elastic insulating layer, wherein the surface is far away from the first conductive layer. When no pressure is applied to the resistive pressure sensor, the first conductive layer is isolated from the second conductive layer, when a pressure which is greater than the pressure threshold is applied to the resistive pressure sensor, the first conductive layer and the second conductive layer contact with each other via the through hole.

### TECHNICAL FIELD

The disclosure relates to the field of sensors, in particular to a resistive pressure sensor and a wearable device.

### BACKGROUND

There are patents related to a fabric pressure sensor which is used for wearable devices and smart textiles. In these patents, a pressure is measured normally with the change of contact resistance between conductive warp yarns and conductive weft yarns. However, these patents have shortcomings as follows: (1) since the yarns have a loose structure, the repeatability of change of contact areas between the conductive warp yarns and the conductive weft yarns is usually poor, and it is difficult to realize linearization, so the degree of linearity of the resistance signal is low, and the repeatability is poor; (2) the conductive coating on the surface of the yarn can be subjected to a pressure and a shear force simultaneously, so the yarn cannot endure long-term cyclic loading, resulting in a limited lifetime; (3) the fabric structure is air and moisture permeable, and the moisture will seriously influence the contact resistance of the yarns, so the sensor is susceptible to moisture change.

Therefore, a pressure sensor with higher reliability and durability is needed.

### SUMMARY

The main objective of the disclosure is to provide a resistive pressure sensor and a wearable device, so as to solve the problem of poor reliability of a fabric pressure sensor in the prior art.

In order to achieve the above objective, according to an aspect of the disclosure, a resistive pressure sensor is provided, the resistive pressure sensor comprises: a first conductive layer; an elastic insulating layer, which is provided on a surface of the first conductive layer, and comprises at least one through hole; and a second conductive layer, which is provided on a surface of the elastic insulating layer, wherein the surface is far away from the first conductive layer; when no pressure is applied to the resistive pressure sensor, the first conductive layer is isolated from the second conductive layer; when a pressure which is larger than a pressure threshold is applied to the resistive pressure sensor, the first conductive layer and the second conductive layer contact with each other via the through hole.

Furthermore, the through hole is a circular through hole or a rectangular through hole.

Furthermore, the first conductive layer electrically connects with a first wire, and the second conductive layer electrically connects with a second wire; the first conductive layer comprises: one or more first electrically contacting parts which are isolated from each other; the projection of the first electrically contacting part on the elastic insulating layer coincides with the through hole by way of one-to-one correspondence, or the projection of the first electrically contacting part on the elastic insulating layer is in the through hole correspondingly; and one or more first electrically connecting parts which are isolated from each other; the first electrically connecting part electrically connects with the one or more first electrically contacting parts, and the first electrically connecting part is used for connecting the first electrically contacting part with the first wire; the second conductive layer comprises: one or more second electrically contacting parts which are isolated from each other and provided in one-to-one correspondence with the first electrically contacting part; the projection of the second electrically contacting part on the elastic insulating layer overlaps, at least in part, with the projection of the first electrically contacting part on the elastic insulating layer; and one or more second electrically connecting parts which are isolated from each other; the second electrically connecting parts electrically connect with the one or more second electrically contacting parts, and the second electrically connecting part is used for connecting the second electrically contacting part with the second wire.

Furthermore, raw materials of the first conductive layer and/or the second conductive layer comprise a composite material of carbon black and silicone rubber; preferably, the elastic insulating layer comprises an elastic fabric made by polyurethane.

Furthermore, the first wire and/or the second wire comprise a silver-plated conductive yarn.

Furthermore, the resistive pressure sensor further comprises: a first fabric layer; the first conductive layer is provided on a surface of the first fabric layer, and the first conductive layer is between the first fabric layer and the elastic insulating layer; and a second fabric layer; the second conductive layer is provided on a surface of the second fabric layer, and the second conductive layer is between the second fabric layer and the elastic insulating layer.

Furthermore, the first fabric layer and/or the second fabric layer comprise a plain-woven polyester fabric.

Furthermore, the resistive pressure sensor further comprises: a first bonding layer, which is between the first fabric layer and the elastic insulating layer, and off the through hole; and a second bonding layer, which is between the second fabric layer and the elastic insulating layer, and off the through hole.

Furthermore, raw materials of the first bonding layer and/or the second bonding layer comprise thermal plastic polyurethane.

According to another aspect of the disclosure, a wearable device is provided, which comprises a resistive pressure sensor; the resistive pressure sensor is any one of the resistive pressure sensors described above.

By applying the technical solutions of the disclosure, when there is no external pressure, the two conductive layers are separated from each other with the elastic insulating layer. When a pressure is applied, the first conductive layer and the second conductive layer contact with the surface via the through hole of the elastic insulating layer in the middle, thereby generating a resistance signal. The greater the pressure is, the larger the contact area between the first conductive layer and the second conductive layer will be, and the smaller the resistance value will be. Because the first conductive layer and the second conductive layer are not contacted only by points or lines, a surface contact is realized. Thus, the stability, repeatability and durability of the pressure sensor is improved dramatically, and the bending resistance and shear resistance is also improved greatly. Moreover, the pressure measuring range can be adjusted by changing the thickness of the elastic insulating layer, the elastic modulus of the elastic insulating layer, the size of the through hole and shape of the through hole. The sensitivity and resistance range of the pressure sensor can be adjusted by controlling the thickness, the surface appearance and the conductivity of the two conductive layers. When the external pressure is equal to the conductive pressure, the first conductive layer and the second conductive layer will contact with each other, and the resistance of the pressure sensor will change from infinity to the threshold resistance value.

### BRIEF DESCRIPTION OF THE DRAWINGS

The drawings which are a part of the disclosure described here are used for providing a further understanding of the disclosure; The drawings of the disclosure and the description of the drawings are used for illustrating the disclosure and not intended to form an improper limit to the disclosure. In the drawings:

FIG. 1 shows a structure diagram of a pressure sensor provided according to an embodiment of the disclosure;

FIG. 2 shows a structure diagram of different working states of the pressure sensor provided in an embodiment;

FIG. 3 shows a structure diagram of the first conductive layer and/or the second conductive layer provided in another embodiment of the disclosure;

FIG. 4 shows a structure diagram of the first conductive layer and/or the second conductive layer provided in another embodiment of the disclosure;

FIG. 5 shows a structure diagram of the first conductive layer and/or the second conductive layer provided in another embodiment of the disclosure; and

FIG. 6 shows a diagram of curves of the external pressure and the resistance of the pressure sensor provided in an embodiment of the disclosure.

The above drawings include the following reference numbers:

1. first fabric layer; 2. second conductive layer; 3. elastic insulating layer; 4. second conductive layer; 5. second fabric layer; 30. through hole.

### DETAILED DESCRIPTION OF THE EMBODIMENTS

Note that, the following detailed description is exemplary, in order to provide a further description of the disclosure. Unless specified otherwise, all technical and scientific terms used in the disclosure have the same meanings as those skilled in the art usually understand.

It should be noted that the terms here are used for describing the specific embodiments, but not intended to limit the exemplary embodiments according to the disclosure. Unless clearly specified otherwise in the context, the singular form used here is intended to include the plural form; moreover, it should be understood that when the term “comprise” and/or “include” is used in the specification, it indicates that there are characteristics, steps, operations, components and/or a combination of them.

As mentioned in the background, the resistive pressure sensor in the prior art measures a pressure mainly by the change of contact resistance between the conductive warp yarns and the conductive weft yarns, and the stability of the pressure sensor is poor. To solve the above technical problem, a resistive pressure sensor and a wearable device are provided.

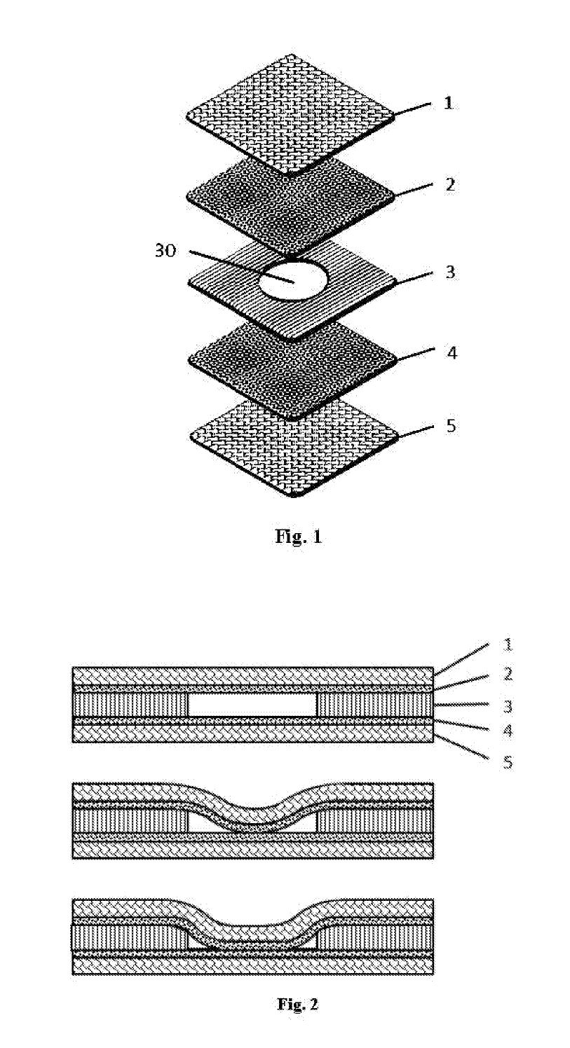

A typical embodiment of the present disclosure provides a resistive pressure sensor; as shown in FIG. 1, the resistive pressure sensor comprises a first conductive layer 2, an elastic insulating layer 3 and a second conductive layer 4. The elastic insulating layer 3 is provided on a surface of the first conductive layer 2, and the elastic insulating layer 3 comprises at least one through hole 30; the second conductive layer 4 is provided on a surface of the elastic insulating layer 3, wherein the surface is far away from the first conductive layer 2.

As shown in the first state diagram in FIG. 2, when no pressure is applied to the resistive pressure sensor, the first conductive layer 2 is isolated from the second conductive layer 4; as shown in the second state diagram and the third state diagram in FIG. 2, when a pressure which is larger than a pressure threshold is applied to the resistive pressure sensor, the first conductive layer 2 and the second conductive layer 4 contact with each other via the through hole 30, thereby conducting the first conductive layer and the second conductive layer and generating a resistance signal; the pressure threshold is a pressure making the first conductive layer and the second conductive layer contact.

The greater the pressure is, the larger a contact area between the first conductive layer and the second conductive layer will be, and the smaller a resistance value will be. Because the first conductive layer and the second conductive layer do not contact with each other by points or lines, but the entire surface of the conductive layer, the resistive pressure sensor realizes a surface contact. Thus the stability, repeatability and durability of the pressure sensor is improved dramatically, and the bending and shear resistance of the sensor is improved greatly. Moreover, the pressure measuring range can be adjusted by changing the thickness of the elastic insulating layer, the elastic modulus of the elastic insulating layer, the size of the through hole and shape of the through hole. The sensitivity and resistance range (including the value of initial resistance) of the resistive pressure sensor can be adjusted by controlling the thickness, the surface appearance and the conductivity of the two conductive layers. When the external pressure is equal to the conductive pressure, the first conductive layer and the second conductive layer will contact with each other, and the resistance of the sensor will change from infinity to a threshold resistance value.

To simplify the manufacture of the resistive pressure sensor, in an embodiment of the disclosure, as shown in FIG. 2 to FIG. 5, the through hole 30 is a circular through hole or a rectangular through hole.

However, the shape of the through hole is not limited to circle or rectangle, the shape of the through hole can be any shape in the prior art, for example, oval or triangle; those skilled in the art can select a proper shape of the through hole according to the actual conditions.

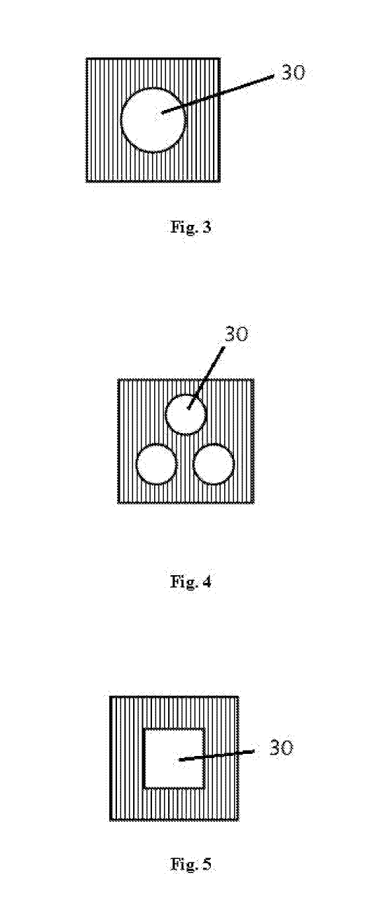

There can be one or more through holes, and those skilled in the art can set a proper number of the through hole according to the actual conditions; as shown in FIG. 3 and FIG. 5, there only one through hole 30 in the elastic insulating layer; as shown in FIG. 4, there are 3 through holes in the elastic insulating layer.

The first conductive layer and the second conductive layer function as sensing pressure, and the projections of the parts on the elastic insulating layer can completely cover the through hole, and can also completely overlap with the through hole; the projections of the parts can be in the through hole; or a part of the projections of the parts is in the through hole, and another part is outside the through hole. Those skilled in the art can set the proper first conductive layer and second conductive layer according to the actual conditions as long as the condition that when the pressure is gradually increased from 0, the contact area between the first conductive layer and the second conductive layer increases gradually, and stops increasing after certain amount is satisfied.

In an embodiment of the disclosure, the first conductive layer electrically connects with a first wire, and the second conductive layer electrically connects with a second wire; the first conductive layer comprises: one or more first electrically contacting parts which are isolated from each other and one or more electrically connecting parts which are isolated from each other; the projection of the first electrically contacting part on the elastic insulating layer coincides with the through hole by way of one-to-one correspondence, or the projection of the first electrically contacting part on the elastic insulating layer is in the through hole correspondingly; the first electrically connecting part electrically connects with the one or more first electrically contacting parts, and the first electrically connecting part is used for connecting the first electrically contacting part with the first wire; the second conductive layer comprises: one or more second electrically contacting parts which are isolated from each other and one or more second electrically connecting parts which are isolated from each other; the second electrically contacting part is provided in one-to-one correspondence with the first electrically contacting part; the projection of the second electrically contacting part on the elastic insulating layer overlaps, at least in part, with the projection of the first electrically contacting part on the elastic insulating layer; and the second electrically connecting part electrically connects with the one or more second electrically contacting parts, and is used for connecting the second electrically contacting part with the second wire. The area of the first electrically contacting part in the first conductive layer is set to be the same as or smaller than the area of the through hole, and the area of the second electrically contacting part in the second conductive layer is set to be the same as or smaller than the area of the through hole, as a result conductive materials can be saved, thereby reducing the cost of the resistive pressure sensor.

When the first conductive layer comprises several first electrically contacting parts, they can be connected in parallel or in series, or in a series-parallel electrical connection relationship; when the resistive pressure sensor comprises several isolated second electrically contacting parts, they can be connected in parallel or in series, or in a series-parallel electrical connection relationship. Those skilled in the art can set the electrical connection relationship of the electrically contacting parts according to the actual conditions.

In a practical application, apart from the structure that both the areas of the first electrically contacting part and the second electrically contacting part are smaller than or equal to the area of the through hole, there can be another structures that the areas of the first electrically contacting part and the second electrically contacting part are not smaller than or equal to the area of the through hole at the same time; for example, the projection of the first electrically contacting part on the elastic insulating layer covers the through hole, and the projection of the second electrically contacting part on the elastic insulating layer is smaller than or equal to the area of the through hole.

The raw materials of the first conductive layer and the second conductive layer can be independently selected from conductive polymer or conductive composite materials. Those skilled in the art can select proper raw materials to form the first conductive layer and the second conductive layer according to the actual conditions. The raw materials of them can be the same or different.

In an embodiment of the disclosure, raw materials of the first conductive layer and the second conductive layer comprise a composite material of carbon black and silicone rubber, which can realize a better conducting effect; the composite material has excellent elasticity and conductivity, so the resistive pressure sensor has a good conductive stability and high durability. Moreover, the composite material adapts to a wide temperature range it is low in cost, and is environment-friendly and non-toxic.

The first conductive layer and the second conductive layer are provided on the surface of the corresponding fabric layer by screen printing, stencil printing or spray printing techniques. Screen printing technique is preferred to coat the conductive material on the surfaces of the first fabric layer and the second fabric layer to form the first conductive layer and the second conductive layer.

The elastic insulating layer can be made of solid plate, film or fabric (which can be woven fabric, knitted fabric, braided fabric or nonwoven fabric). The raw material of the solid plate can be silicone, polyurethane or other elastomeric polymer materials. The raw material of the film can also be silicone, polyurethane or other elastomeric polymer materials; the fabric as the elastic insulating layer can be made from natural cellulose fibers or artificial fibers. Those skilled in the art can select the elastic insulating layer of proper materials according to the actual conditions.

In another embodiment of the disclosure, the elastic insulating layer 3 comprises an elastic fabric formed by polyurethane. The elastic fabric has good insulating property, highly compressible and resilient, soft and bendable.

The first wire and the second wire of the disclosure can be independently selected from the wires with any material in the prior art; those skilled in the art can select the wire of proper materials according to the actual conditions, and can select the materials of the first wire and the second wire to be the same or different according to the actual conditions.

The first conductive layer and the second conductive layer can be connected with the wires respectively by welding, gluing, sewing, hot-pressing or embroidering.

For realizing a conductive connection with good stability, high reliability and good flexibility, the first wire and/or the second wire comprise a silver-plated conductive yarn.

In another embodiment of the disclosure, as shown in FIG. 1 and FIG. 2, the resistive pressure sensor further comprises a first fabric layer 1 and a second fabric layer 5; the first conductive layer 2 is provided on a surface of the first fabric layer 1, and the first conductive layer 2 is between the first fabric layer 1 and the elastic insulating layer 3; the second conductive layer 4 is provided on a surface of the second fabric layer 5, and the second conductive layer 4 is between the second fabric layer 5 and the elastic insulating layer 3. The two fabric layers can meet the requirements of the wearable device in the prior art, and can insulate the two conductive layers from body, thereby preventing the user from getting an electric shock.

The first fabric layer and the second fabric layer can be the fabric layers with any material in the prior art, for example, woven fabric, knitted fabric, braided fabric or nonwoven fabric. Those skilled in the art can select the fabric layer of proper materials according to the actual conditions, and can set the first fabric layer and the second fabric layer to be the same or different according to the actual conditions.

For further ensuring a stable connection of each part of the pressure sensor and to preliminary package the pressure sensor, in an embodiment of the disclosure, the first fabric layer and/or the second fabric layer comprise a plain-woven polyester fabric.

In another embodiment of the disclosure, the resistive pressure sensor further comprises: a first bonding layer and a second bonding layer; the first bonding layer is between the first fabric layer and the elastic insulating layer, off the through hole; the second bonding layer is between the second fabric layer and the elastic insulating layer, off the through hole. As a result, the elastic insulating layer and the first fabric layer of the resistive pressure sensor can be bonded together well, and the elastic insulating layer and the second fabric layer of the resistive pressure sensor can be bonded together well, thereby further ensuring that the fabric layer can be fixed on the elastic insulating layer firmly, and further ensuring the reliability and stability of the resistive pressure sensor.

When the conductive layer covers the fabric layer completely, the bonding layer is provided on a surface of the conductive layer, and the projection of the bonding layer on the elastic insulating layer does not overlap with the through hole.

When the conductive layer covers the fabric layer incompletely, the bonding layer is provided on an area, which is not provided with the conductive layer, of the surface of the fabric layer, or the bonding layer is provided on an area, which is not provided with the conductive layer, of the surface of the fabric layer and a part of a surface, which is far away from the fabric layer, of the conductive layer (the projection of the part on the elastic insulating layer does not overlap with the through hole).

The materials of the first bonding layer and the second bonding layer can be any material with bonding effect in the prior art. Those skilled in the art can select the proper bonding material to form the first bonding layer and the second bonding layer according to the actual conditions. For example, one can select hot-melt TPU (Thermal Plastic Polyurethanes) bonding agent, acrylate bonding agent, phenolic bonding agent and/or epoxy bonding agent, and can select the same or different material to form the first bonding layer and the second bonding layer according to the actual conditions.

In another embodiment of the disclosure, raw materials of the first bonding layer and/or the second bonding layer comprise the hot-melt TPU, which can realize simple and fast heat-press bonding, simplify processing and save the cost under the premise of ensuring reliability and stability of the pressure sensor.

In another typical embodiment of the disclosure, a wearable device is provided, which comprises the resistance-type pressure sensor; the resistance-type pressure sensor is any one of the resistance-type pressure sensors described above.

The wearable device has good performance and is stable because of the resistance-type pressure sensor.

The resistive pressure sensor in the disclosure can be manufactured by any method that can be implemented in the prior art. In an embodiment of the disclosure, a manufacturing method of the resistive pressure sensor comprises that: conductive layers are printed on the first fabric layer and the second fabric layer respectively, so as to form the first conductive layer and the second conductive layer; the elastic insulating layer and the two bonding layers are bonded, and the two bonding layers are on two surfaces of the elastic insulating layer respectively; the through hole is formed on the bonded elastic insulating layer by cutting through a cutting tool or stamping; the first conductive layer and the second conductive layer are connected with the wires respectively; the first fabric layer and the second fabric layer coated with the conductive layers are aligned at the elastic insulating layer, and they are bonded through the bonding layer; then, the resistive pressure sensor is formed.

For making those skilled in the art understand the technical solutions of the disclosure more dearly, the technical solutions of the disclosure are illustrated below in combination with the specific embodiments.

### Embodiment

The structure of the resistive pressure sensor is shown in FIG. 1. The resistive pressure sensor comprises the first fabric layer 1, the first conductive layer 2, the first bonding layer, the elastic insulating layer 3, the second bonding layer, the second conductive layer 4, and the second fabric layer 5 in order. The first conductive layer 2 is provided on the surface of the first fabric layer 1, and covers the first fabric layer 1 completely; the second conductive layer 4 is provided on the surface of the second fabric layer 5, and covers the second fabric layer 5 completely; the first bonding layer is provided on a part of area of the conductive layer, and the projection of the area on the elastic insulating layer 3 does not overlap with the through hole 30; the second bonding layer is provided on a part of area of the conductive layer, and the projection of the area on the elastic insulating layer 3 does not overlap with the through hole 30; the elastic insulating layer has a circular through hole 30. The first fabric layer 1 and the second fabric layer 5 are plain-woven polyester fabric; the elastic insulating layer 3 is warp-knitted elastic fabric made of polyurethane filament yarns; the first bonding layer and the second bonding layer are hot-melt TPU layers; and the first conductive layer 2 and the second conductive layer 4 are composite material layers of carbon black and silicone rubber.

The manufacturing method of the resistive pressure sensor comprises that: the composite material of carbon black and silicone rubber is uniformly coated on the surfaces of the first fabric layer 1 and the second fabric layer 5; the silicone is cured after heating, so as to form the first conductive layer 2 and the second conductive layer 4;

The warp-knitted elastic fabric and the hot-melt TPU layers are bonded by heat-pressing, wherein the elastic insulating layer 3 is in the middle and the hot-melt TPU layers are at the two sides;

A laser cutting machine is used for cutting the bonded elastic insulating layer 3 to form a single circular through hole;

The first fabric layer 1 provided with the first conductive layer 2 and the second fabric layer 5 provided with the second conductive layer 4 are connected to the silver-plated conductive yarns by sewing; and

The elastic insulating layer 3 and the two fabric layers are bonded by hot-pressing, so as to form the structure shown in FIG. 1; the first bonding layer and the second bonding layer are not shown in the figure.

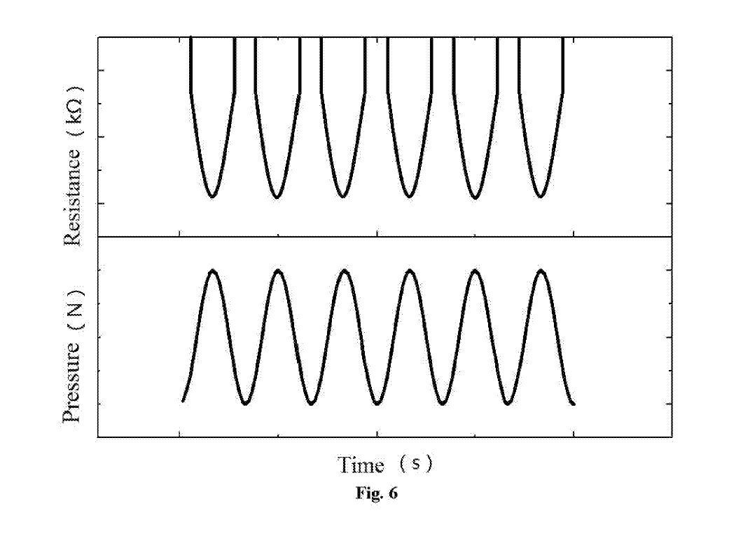

A resistance pressure curve of the resistive pressure sensor in the case of cyclic loading is tested by an electromechanically coupled device. The cyclic pressure is provided by a universal testing machine, and the resistance is measured by a multimeter whose the clock is synchronized with the universal testing machine; the test result is shown in FIG. 6.

As shown in FIG. 6, the pressure on the pressure sensor has a good linear relation with its resistance, and has high stability and repeatability. The resistive pressure sensor is simple and light and thin in structure, and can be integrated in apparel fabrics well; the pressure measuring range, initial resistance and sensitivity of the resistive pressure sensor are all adjustable; the bending and shear resistance of the resistive pressure sensor is also excellent; the resistive pressure sensor is very durable with a fatigue life over one million cycles; the resistive pressure sensor can be applied to smart shoes and insoles, smart socks, smart cushions, smart clothing and other smart textile products.

Because of the surface-to-surface contact between the first conductive layer and the second conductive layer, the resistive pressure sensor successfully solves the problem of small contact area in the prior art, and thus has good stability, repeatability and durability.

It can be seen from the above description that the embodiment of the disclosure achieves the following technical effects:

(1) the resistive pressure sensor of the disclosure realizes a surface contact mode, which dramatically improves the stability, repeatability and durability of the resistive pressure sensor, and also greatly improves the bending and shear resistance of the sensor; moreover, the pressure measuring range can be adjusted by changing the thickness of the elastic insulating layer, the elastic modulus of the elastic insulating layer, the size and shape of the through hole; the sensitivity and resistance range of the pressure sensor can be adjusted by controlling the thickness, the surface appearance and the conductivity of the two conductive layers; when the external pressure is equal to the conductive pressure, the first conductive layer and the second conductive layer contact with each other, and the resistance of the sensor changes from infinity to the threshold resistance value.

(2) The wearable device has good performance and is stable because of the resistance-type pressure sensor.

The above is only the preferred embodiment of the disclosure and not intended to limit the disclosure; for those skilled in the art, the disclosure may have various modifications and changes. Any modifications, equivalent replacements, improvements and the like within the spirit and principle of the disclosure shall be within the scope of protection of the disclosure.

What is claimed is:

1. A resistive pressure sensor, wherein the resistive pressure sensor comprising:
a first conductive layer (2);
an elastic insulating layer (3), which is provided on a surface of the first conductive layer (2), and the elastic insulating layer (3) comprises at least one through hole (30); and
a second conductive layer (4), which is provided on a surface of the elastic insulating layer (3), wherein the surface is far away from the first conductive layer (2); when no pressure is applied to the resistive pressure sensor, the first conductive layer (2) is isolated from the second conductive layer (4); when a pressure which is larger than a pressure threshold is applied to the resistive pressure sensor, the first conductive layer (2) and the second conductive layer (4) contact with each other via the through hole (30).

2. The resistive pressure sensor as claimed in claim 1, wherein the through hole (30) is a circular through hole or a rectangular through hole.

3. The resistive pressure sensor as claimed in claim 1, wherein the first conductive layer (2) electrically connects with a first wire, and the second conductive layer (4) electrically connects with a second wire;
the first conductive layer (2) comprises:
one or more first electrically contacting parts which are isolated from each other; the projection of the first electrically contacting part on the elastic insulating layer (3) coincides with the through hole (30) by way of one-to-one correspondence, or the projection of the first electrically contacting part on the elastic insulating layer (3) is in the through hole (30) correspondingly, and
one or more first electrically connecting parts which are isolated from each other; the first electrically connecting part electrically connects with the one or more first electrically contacting parts, and the first electrically connecting part is used for connecting the first electrically contacting part with the first wire;
the second conductive layer (4) comprises:
one or more second electrically contacting parts which are isolated from each other and provided in one-to-one correspondence with the first electrically contacting part; the projection of the second electrically contacting part on the elastic insulating layer (3) overlaps, at least in part, with the projection of the first electrically contacting part on the elastic insulating layer (3); and
one or more second electrically connecting parts which are isolated from each other, the second electrically connecting part electrically connects with the one or more second electrically contacting parts, and the second electrically connecting part is used for connecting the second electrically contacting part with the second wire.

4. The resistive pressure sensor as claimed in claim 1, wherein raw materials of the first conductive layer (2) and/or the second conductive layer (4) comprise a composite material of carbon black and silicone rubber, preferably, the elastic insulating layer (3) comprises an elastic fabric made by polyurethane.

5. The resistive pressure sensor as claimed in claim 3, wherein the first wire and/or the second wire comprise a silver-plated conductive yarn.

6. The resistive pressure sensor as claimed in claim 1, wherein the resistive pressure sensor further comprising:
a first fabric layer (1); the first conductive layer (2) is provided on a surface of the first fabric layer (1), and the first conductive layer (2) is between the first fabric layer (1) and the elastic insulating layer (3); and
a second fabric layer (5); the second conductive layer (4) is provided on a surface of the second fabric layer (5), and the second conductive layer (4) is between the second fabric layer (5) and the elastic insulating layer (3).

7. The resistive pressure sensor as claimed in claim 6, wherein the first fabric layer (1) and/or the second fabric layer (5) comprise a plain-woven polyester fabric.

8. The resistive pressure sensor as claimed in claim 6, wherein the resistive pressure sensor further comprising:
a first bonding layer, which is between the first fabric layer (1) and the elastic insulating layer (3), off the through hole (3); and
a second bonding layer, which is between the second fabric layer (5) and the elastic insulating layer (3), off the through hole (3).

9. The resistive pressure sensor as claimed in claim 8, wherein raw materials of the first bonding layer and/or the second bonding layer comprise a hot-melt TPU.

10. A wearable device, comprising a resistive pressure sensor, wherein the resistive pressure sensor is the resistive pressure sensors as claimed in claim 1.

11. The wearable device as claimed in claim 10, wherein the through hole (30) is a circular through hole or a rectangular through hole.

12. The wearable device as claimed in claim 10, wherein the first conductive layer (2) electrically connects with a first wire, and the second conductive layer (4) electrically connects with a second wire;
the first conductive layer (2) comprises:
one or more first electrically contacting parts which are isolated from each other; the projection of the first electrically contacting part on the elastic insulating layer (3) coincides with the through hole (30) by way of one-to-one correspondence, or the projection of the first electrically contacting part on the elastic insulating layer (3) is in the through hole (30) correspondingly; and
one or more first electrically connecting parts which are isolated from each other; the first electrically connecting part electrically connects with the one or more first electrically contacting parts, and the first electrically connecting part is used for connecting the first electrically contacting part with the first wire;
the second conductive layer (4) comprises:
one or more second electrically contacting parts which are isolated from each other and provided in one-to-one correspondence with the first electrically contacting part; the projection of the second electrically contacting part on the elastic insulating layer (3) overlaps, at least in part, with the projection of the first electrically contacting part on the elastic insulating layer (3); and
one or more second electrically connecting parts which are isolated from each other; the second electrically connecting part electrically connects with the one or more second electrically contacting parts, and the second electrically connecting part is used for connecting the second electrically contacting part with the second wire.

13. The wearable device as claimed in claim 10, wherein raw materials of the first conductive layer (2) and/or the second conductive layer (4) comprise a composite material of carbon black and silicone rubber, preferably, the elastic insulating layer (3) comprises an elastic fabric made by polyurethane.

14. The wearable device as claimed in claim 12, wherein the first wire and/or the second wire comprise a silver-plated conductive yarn.

15. The wearable device as claimed in claim 10, wherein the resistive pressure sensor further comprising:
a first fabric layer (1); the first conductive layer (2) is provided on a surface of the first fabric layer (1), and the first conductive layer (2) is between the first fabric layer (1) and the elastic insulating layer (3); and
a second fabric layer (5); the second conductive layer (4) is provided on a surface of the second fabric layer (5), and the second conductive layer (4) is between the second fabric layer (5) and the elastic insulating layer (3).

16. The wearable device as claimed in claim 15, wherein the first fabric layer (1) and/or the second fabric layer (5) comprise a plain-woven polyester fabric.

17. The wearable device as claimed in claim 15, wherein the resistive pressure sensor further comprising:
a first bonding layer, which is between the first fabric layer (1) and the elastic insulating layer (3), off the through hole (3); and
a second bonding layer, which is between the second fabric layer (5) and the elastic insulating layer (3) off the through hole (3).

18. The wearable device as claimed in claim 17, wherein raw materials of the first bonding layer and/or the second bonding layer comprise a hot-melt TPU.
